(19) United States
(12) Patent Application Publication
(10) Pub. No.: US 2023/0303320 A1
(43) Pub. Date: Sep. 28, 2023

(54) Portable Leaf Catcher Device and Method of Use

(71) Applicant: Rebecca Davis (fka Numer), Bethel Park, PA (US)

(72) Inventor: Rebecca Davis (fka Numer), Bethel Park, PA (US)

(21) Appl. No.: 18/176,802

(22) Filed: Mar. 1, 2023

Related U.S. Application Data
(60) Provisional application No. 63/322,659, filed on Mar. 23, 2022.

(51) Int. Cl. B65F 1/02

(52) U.S. Cl. CPC B65F 1/02; B65F 2220/101; B65F 2220/1063; B65F 2230/152; B65F 2250/105

(57) ABSTRACT

The present invention relates to a novel leaf and debris catcher device for catching leaves and other debris blown into and around corners of a home, fence, garage, and more, due to strong winds and other weather and seasonal conditions. The device has a mesh screen around the side surfaces and the bottom surface and has an open top surface from where the leaves and other debris are blown into the device. The device is portable, biodegradable, and can be folded when not in use. The device has a plurality of poles that enable freestanding of the catcher device which can be placed indoors or outdoors. The leaves and debris collected inside the device can be easily collected for disposal via a reusable mesh trash bag.

### CROSS-REFERENCE TO RELATED APPLICATION

The present application claims priority to, and the benefit of, U.S. Provisional Application No. 63/322,659, which was filed on Mar. 23, 2022, and is incorporated herein by reference in its entirety.

### FIELD OF THE INVENTION

The present invention relates generally to the field of leaf catcher devices. More specifically, the present invention relates to a novel biodegradable catch-all device for preventing the buildup of leaves in corners near homes, garages, and other outdoor areas because of strong winds. The device has a screen supported by several tent poles to collect the leaves for disposal. The device is portable, foldable, and biodegradable. Accordingly, the present disclosure makes specific reference thereto. Nonetheless, it is to be appreciated that aspects of the present invention are also equally applicable to other like applications, devices, and methods of manufacture.

### BACKGROUND

By way of background, leaves and twigs fall from trees during autumn season and windy days. In fact, the autumnal leaf drop is a form of self-protection. The changes in weather and daylight trigger a hormone that releases a chemical message to each leaf that it is time to prepare for winter. The wind exerts a force on the leaves to dislodge the leaves from their branches in the fall. Strong gusty winds can shred leaves, tear off flowers, and even break branches. Raking is probably the most back-breaking approach to leaf removal. It works best in small yards or planting beds. Leaves also gather in the corners of driveways, on stairs, by garage doors, etc. It is difficult to remove the leaves gathered in the corners using existing tools. People may have to bend, use rakes, brooms and more to clean leaves and many times, such areas are hard to reach.

Leaves when left for long periods of time in corners rot and develop mold and moss. This leads to rodent and insect infestations. Buildup of leaves provides plenty of hiding places for rats and more. Leaves also lead to improperly managed compost piles which can be food for rodents. People desire a device that helps users in cleaning up leaves, twigs, and other outdoor debris collected at corners.

Therefore, there exists a long-felt need in the art for a device that saves extensive time and effort when cleaning up leaves, twigs, and other outdoor debris at corners. There is also a long-felt need in the art for a device that eliminates use of existing rakes, brooms, and other devices for cleaning leaves. Additionally, there is a long-felt need in the art for a novel device that collects leaves, twigs, and more, falling from trees. Moreover, there is a long-felt need in the art for a device that prevents mold and moss from accumulating from fallen leaves. Further, there is a long-felt need in the art for a device that allows users to simply gather up the leaves collected at corners. Finally, there is a long-felt need in the art for a device that allows users to easily collect leaves from corners in homes, garages, and other outdoor areas for disposal.

The subject matter disclosed and claimed herein, in one embodiment thereof, comprises a portable leaf catcher device. The leaf catcher device is designed to position at a corner of a home, garage, and more for collecting leaves blowing therein. The device has a mesh screen with an open top surface from which the leaves fall inside the device. The device is in the shape of a triangular prism and has a top and open triangular surface, a mesh screened bottom triangular surface, three rectangular meshed screens, the top triangular surface formed of a first set of three poles interconnected to form a right triangle, the bottom triangular surface formed of second set of three poles interconnected to form a triangle congruent to the top triangular surface, a third set of three vertical poles interconnected to the first set at the top ends thereof and interconnected to the second set at the bottom ends thereof, wherein the leaves are blown into the device from the open top triangular surface and are collected and secured by the meshed rectangular screens and bottom meshed screen. A user can collect the leaves from the device into a garbage bag for disposal.

In this manner, the leaf catcher device of the present invention accomplishes all of the forgoing objectives and provides users with a tent-like tool designed to catch leaves and other debris blown into corners of a home, garage, and more. The device has mesh screen with an open top area and allows users to simply gather up the leaves inside the screen for disposal via a trash bag. The device saves extensive time and effort when cleaning up leaves, twigs, and other outdoor debris and prevents attraction of rodents, and accumulation of mold and moss.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable leaf catcher device. The leaf catcher device is configured to position at a corner of a home, garage, and more for collecting leaves blowing therein. The device is in the shape of a triangular prism and further comprising a top and open triangular surface, a mesh screen bottom triangular surface, three rectangular meshed screens, the top triangular surface formed of a first set of three poles interconnected to form a right triangle, the bottom triangular surface formed of second set of three poles interconnected to form a triangle congruent to the top triangular surface, a third set of three vertical poles interconnected to the first set at the top ends thereof and interconnected to the second set at the bottom ends thereof, wherein the leaves are blown into the device from the open top triangular surface and are collected and secured by the meshed rectangular screens and bottom meshed screen.

In yet another embodiment, the leaf catcher device is made from biodegradable material and the poles are flexible.

The subject matter disclosed and claimed herein, in one embodiment thereof, comprises a leaf catcher device. The leaf catcher device has a structural frame for collecting leaves, twigs, debris and more therein, the structural frame includes a first triangular mesh screen supported by three tent poles, three rectilinear faces extending vertically upwards along the three tent poles, each rectangular face has a mesh screen, a second triangular surface positioned along the top ends of the three rectilinear faces, the second triangular surface does not have a mesh screen, the device is positioned along a corner wherein the two rectilinear faces positioned along the walls forming the corner, the leaves, twigs, and debris are collected inside the device blown through the second triangular surface.

In yet another embodiment, the leaf catcher device is foldable. One of the rectilinear faces can be pushed towards the common edge of the other two rectilinear faces, enabling the rectangular face to fold.

In another aspect of the present invention, a disposable bag can be used for collecting the leaves which buildup inside the leaf catcher device for disposing the leaves.

In yet another embodiment, the biodegradable leaf catcher device of the present invention is easily and efficiently manufactured, marketed, and available to consumers in a cost-effective manner and is easily installed and used by users for cleaning up leaves, twigs, and other outdoor debris without spending extensive time and effort.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a standalone view of one potential embodiment of a portable leaf catcher device of the present invention in accordance with the disclosed architecture;

FIG. 2 illustrates a perspective view showing the biodegradable leaf catcher device of the present invention positioned at a corner of a building for catching leaves in accordance with the disclosed architecture;

FIG. 3 illustrates a perspective view showing the leaves collected in the leaf catcher device being bagged in a disposable bag for disposal in accordance with the disclosed architecture;

FIG. 4 illustrates a perspective view of the leaf catcher device in a folded state when not in use in accordance with the disclosed architecture; and

FIG. 5 illustrates a flow diagram depicting a process of using the leaf catcher device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that saves extensive time and effort when cleaning up leaves, twigs, and other outdoor debris at corners. There is also a long-felt need in the art for a device that eliminates use of existing rakes, brooms, and other devices for cleaning leaves. Additionally, there is a long-felt need in the art for a novel device that collects leaves, twigs, and more, falling from trees. Moreover, there is a long-felt need in the art for a device that prevents mold and moss from accumulating around fallen leaves. Further, there is a long-felt need in the art for a device that allows users to simply gather up the leaves collected at corners of building, fences, and other structures. Finally, there is a long-felt need in the art for a device that allows users to easily collect leaves from corners in homes, garages, and other outdoor areas for disposal.

The present invention, in one exemplary embodiment, is a leaf catcher device. The leaf catcher device is used for collecting leaves, twigs, debris, and more therein, and includes a mesh screen supported by a plurality of poles (i.e., tent poles). Users can assemble the device in a corner area and allow leaves and other debris to be blown into the device over a period of time. The leaves are then easily collected for disposal via a reusable mesh trash bag.

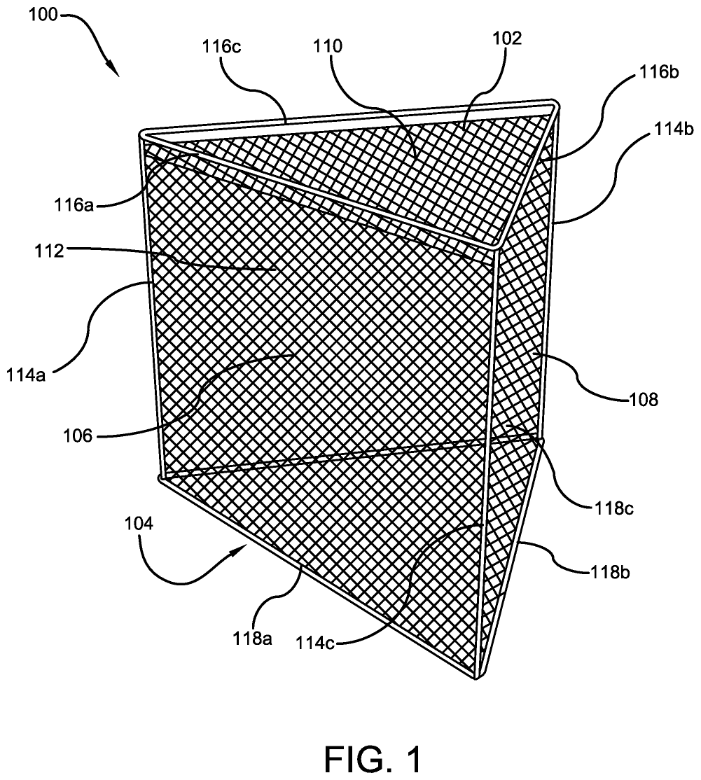

Referring initially to the drawings, FIG. 1 illustrates a standalone view of one potential embodiment of a portable leaf catcher device of the present invention in accordance with the disclosed architecture. The portable leaf catcher device 100 of the present invention is designed to be placed in corners near homes, garages, fences, gardens, and other outdoor areas for catching leaves and other debris blown into the corners. More specifically, the leaf catcher device 100 is in the form of a triangular or rectilinear prism having a closed bottom triangular base 104, an open top triangular open surface area 102, and three closed rectilinear faces 106, 108, 110. The base 104 and the rectilinear faces 106, 108, 110 are formed of mesh screen 112 with the top triangular open surface area 102 being open. Leaves and other debris are automatically blown inside the device 100 through the top open surface area 102 and are collected and wherein a buildup of leaves is contained within the device 100.

The leaf catcher device 100 has three substantially parallel vertical wall poles 114a-c and top three poles 116a-c interconnectable with the top ends of the said vertical wall poles 114a-c. Three bottom horizontal poles 118a-c are interconnectable with the bottom ends of the vertical wall poles 114a-c, the top three poles 116a-c, and the bottom three poles 118a-c form congruent triangles 102, 104, respectively.

The faces 106, 108 are substantially at right angles relative to each other for easy positioning at a corner of a building, fence, or outdoor area. The third rectangular face 110 extends across the wall poles 114a, 114b. In the preferred embodiment, the device 100 has a height of preferably about two feet and can range between one (1) foot and four (4) feet for positioning in different areas.

The poles 114a-c, 116a-c, and 118a-c can be made from wood, a biodegradable plastic, or a composite material and assist to hold up the leaf catcher device 100. The device 100 has a one-piece construction and can fragment into very small microbial particles having a size of less than 5000 Dalton for conversion into biomass. The mesh screen 112 is washable, durable, and can be sewn to the poles (i.e., tent poles) thereby eliminating any gaps between the mesh screen 112 and any of the, for example, tent poles.

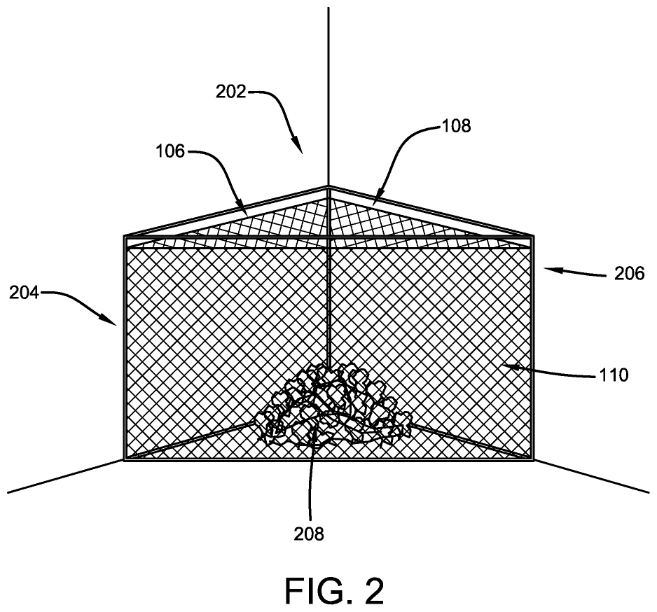

FIG. 2 illustrates a perspective view showing the biodegradable leaf catcher device of the present invention positioned on the ground at a corner of a building for catching leaves in accordance with the disclosed architecture. The device 100 is designed to be positioned at a corner 202 of an indoor or outdoor area or structure. The device 100 is installed without any tools or professional help and the rectilinear faces 106, 108 can rest against the walls 204, 206 of the structure or any other surfaces forming the corner 202. It should be noted that the device 100 can independently stand upright (i.e., freestanding) and be stable without any external support such as from the walls 204, 206 and therefore, can be used in open areas (i.e., fence areas) as well.

The device 100 rests on the bottom or base surface 104 and the top open triangular surface area 102 allows the leaves 208 to be blown over, around, and into the device 100 when wind and leaves are blown therearound. The leaves 208 rest on the bottom surface 104 such that the leaves 208 can be easily collected for disposal and thereby obviating a majority of manual effort to collect and clean leaves from hard-to-reach areas.

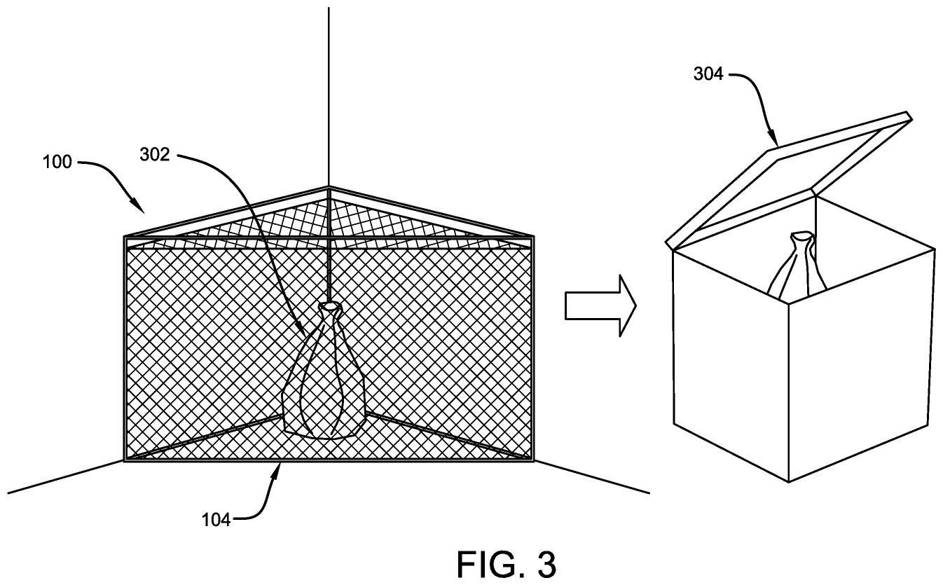

FIG. 3 illustrates a perspective view showing the leaves collected in the leaf catcher device being bagged in a disposable bag for disposal in accordance with the disclosed architecture. The advantage of the leaf catcher device 100 is that leaves, twigs, and other debris blown into corners of a home, garage, fence, and more are easily collected on the bottom surface 104 and thereby a user does not have to spend a lot of effort in cleaning the corners. A disposable garbage bag 302 can be used for collecting the leaves blown into the device 100 for disposal into a dustbin 304 or any other disposal container or disposal site. The device 100 prohibits development of mold and moss in and around corners of homes, fences, and garages. The device 100 is reusable and can be used in both indoor and outdoor settings/environments.

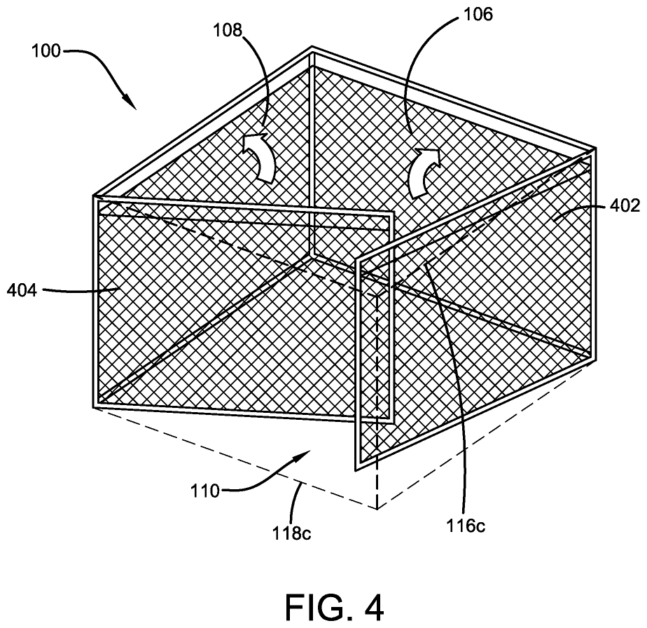

FIG. 4 illustrates a perspective view of the leaf catcher device in a folded state when not in use in accordance with the disclosed architecture. The device 100 is portable, flexible, and can be folded when not used. Further, the device 100 is weatherproof and can withstand weather elements such as rain and snowfall. For folding the device 100, the top pole 116c and the parallel bottom pole 118c are pushed towards pole 114c along the centers thereof, such that rectilinear face 110 is bent into two generally equal portions 402, 404 substantially equal to the other rectilinear faces 106, 108. The device 100 in the folded position can be secured using clips or other fasteners enabling a user to easily store and transport the device 100. The device 100 can be installed and unfolded without fasteners, screws, bolts, or tools.

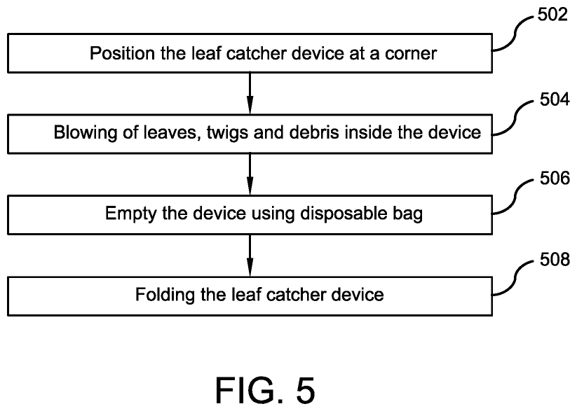

FIG. 5 illustrates a flow diagram depicting a process of using the leaf catcher device of the present invention in accordance with the disclosed architecture. Initially, the device is positioned at a corner of an indoor or outdoor area as per preferences of a user (Step 502). The device 100 in the preferred embodiment does not require any digging or pre-installation steps to the ground or floor. Alternatively, the tent poles can be fastened into the ground for permanent installation. Then, the leaves, twigs, debris and more are automatically collected inside the device 100 on the bottom triangular surface (Step 504). Based on the requirements of a user, the device 100 is emptied using a disposable bag in the preferred embodiment as illustrated in FIG. 3 (Step 506). In other embodiments, the device 100 can be emptied directly into a dustbin by a user by transferring the leaves and more from the device 100 to the dustbin. After use, the device 100 can be folded for easy storage and carriage (Step 508).

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “portable leaf catcher device”, “leaf catcher device”, “biodegradable leaf catcher device”, and “device” are interchangeable and refer to the biodegradable and portable leaf catcher device 100 of the present invention.

Notwithstanding the forgoing, the biodegradable and portable leaf catcher device 100 of the present invention can be of any suitable size and configuration as is known in the art without affecting the overall concept of the invention, provided that it accomplishes the above-stated objectives. One of ordinary skill in the art will appreciate that the biodegradable and portable leaf catcher device 100 as shown in the FIGS. are for illustrative purposes only, and that many other sizes and shapes of the biodegradable and portable leaf catcher device 100 are well within the scope of the present disclosure. Although the dimensions of the biodegradable and portable leaf catcher device 100 are important design parameters for user convenience, the biodegradable and portable leaf catcher device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable debris catcher device comprising:
a portable debris catcher for placement in corners having a plurality of upright sides, a bottom side, and an open top area to capture debris therein;
wherein each pair of said plurality of upright sides connected along a terminal vertical edge;
wherein at least two of said plurality of upright sides forming at least one right angle;
wherein said terminal vertical edges having poles for retaining said plurality of upright sides in a vertical orientation; and
further wherein said plurality of upright sides are mesh screen.

2. The portable debris catcher device of claim 1, wherein said plurality of upright sides having three upright sides, and further wherein said three upright sides and said bottom side forming an open triangular prism.

3. The portable debris catcher device of claim 1, wherein said plurality of upright sides having four upright sides, and further wherein said four upright sides and said bottom side forming an open rectilinear prism.

4. The portable debris catcher device of claim 1, wherein each of said plurality of upright sides having a top horizontal pole and a bottom horizontal pole.

5. The portable debris catcher device of claim 1, wherein each of said top horizontal pole and said bottom horizontal pole attached between a pair of vertical poles.

6. The portable debris catcher device of claim 5, wherein said top horizontal poles attached to a top end of said vertical pole and said bottom horizontal poles attached to a bottom end of said vertical poles.

7. The portable debris catcher device of claim 6, wherein said plurality of upright sides having a height from about 1 foot to about 4 feet.

8. The portable debris catcher device of claim 7, wherein said portable debris catcher having a one-piece construction.

9. The portable debris catcher device of claim 8, wherein said portable debris catcher is freestanding.

10. The portable debris catcher device of claim 9, wherein said plurality of upright sides sewn to said poles.

11. The portable debris catcher device of claim 10, wherein said plurality of upright sides are flexible.

12. The portable debris catcher device of claim 11, wherein said poles are flexible.

13. The portable debris catcher device of claim 12, wherein said portable debris catcher is foldable.

14. A portable debris catcher device comprising:
a portable debris catcher for placement in corners having a plurality of upright sides, a bottom side, and an open top area to capture debris therein;
wherein each pair of said plurality of upright sides connected along a terminal vertical edge;
wherein at least two of said plurality of upright sides forming at least one right angle;
wherein said terminal vertical edges having poles for retaining said plurality of upright sides in a vertical orientation;
wherein said plurality of upright sides are mesh screen;
wherein said plurality of upright sides having three upright sides;
wherein said three upright sides and said bottom side forming an open triangular prism;
wherein each of said plurality of upright sides having a top horizontal pole and a bottom horizontal pole;
wherein each of said top horizontal pole and said bottom horizontal pole attached between a pair of vertical poles; and
further wherein said portable debris catcher is freestanding.

15. The portable debris catcher device of claim 14, wherein said plurality of upright sides having a height from about 1 foot to about 4 feet.

16. The portable debris catcher device of claim 15, wherein said portable debris catcher having a one-piece construction.

17. The portable debris catcher device of claim 16, wherein said portable debris catcher is foldable.

18. A method of collecting leaves and debris from a corner, the method comprising the steps of:
providing a portable debris catcher having a plurality of upright sides, a bottom side, and an open top area to capture debris therein;
connecting each pair of said plurality of upright sides along a terminal vertical edge;
forming at least one right angle with at least two of said plurality of upright sides;
wherein said terminal vertical edges having poles for retaining said plurality of upright sides in a vertical orientation;
wherein said plurality of upright sides are mesh screen;
wherein said plurality of upright sides having three upright sides;
forming said three upright sides and said bottom side into an open triangular prism;
wherein each of said plurality of upright sides having a top horizontal pole and a bottom horizontal pole; and
freestanding said portable debris catcher in a corner.

19. The method of collecting leaves and debris of claim 18, wherein said portable debris catcher having a one-piece construction.

20. The method of collecting leaves and debris of claim 19, wherein said portable debris catcher is foldable.
